(19) United States
(12) Patent Application Publication
(10) Pub. No.: US 2007/0160820 A1
(43) Pub. Date: Jul. 12, 2007

(54) Architectural ferrocement laminar automated construction

(76) Inventor: Bruce Irven Waters JR., Austin, TX (US)

Correspondence Address: Bruce Irven Waters, Jr., P.O. Box 26930, Austin, TX, 78755, US

(21) Appl. No.: 11/327,683

(22) Filed: Jan. 9, 2006

(51) Int. Cl. B29C 35/08; B32B 27/32; G06F 19/00

(52) U.S. Cl. 428/220; 264/497; 264/113; 425/174; 425/375; 700/120; 428/323

(57) ABSTRACT

A method for producing free form three-dimensional architectural objects by placing construction materials in a matrix of sequential layers or laminations along with fill materials intended for later removal. A digital model specifies the composition of various areas of each lamination so that appropriate materials result in corresponding areas of the finished objects. The relatively void-free laminations inherently provide support to placed material in all directions save the direction in which successive laminations progress. Support in the direction laminations form comes from accelerations, usually the acceleration due to gravity. The uniformity of support obviates the need for large-scale tensile strengths in the pattern of the objects under construction during the placement process. The method supplies the ultimate required object tensile strengths, via a process called activation, in large volumes of the matrix often involving the entire matrix volume. Since activation occurs after matrix deposition, the activation does not add a time requirement proportional to the total piece count of the placed construction materials but proceeds at its characteristic pace in parallel across the entire volume to which activation is applied. In the embodiment producing ferrocement objects, laminar automatic placement of unactivated cementitous materials naturally supports the forming objects within the matrix, whatever their geometries, without activation. The usual practice of the art contrasts with the present invention by requiring application of wet (activated) cementitious material to a reinforcement structure that must support the weight of the wet material in addition to its own weight during construction or employ costly custom supplemental support means until the structure cures enough to become self-supporting. Wet application of material to an intricate reinforcement network in situ severely challenges any automation and the manual labor alternative becomes extremely costly except in locations with an oversupply of laborers.

### BACKGROUND OF THE INVENTION

### REFERENCES CITED

U.S. PATENT DOCUMENTS

| | | | |
|---|---|---|---|
| 4839115 | June 1989 | Babcock et al | 264/42 |
| 5143674 | September 1992 | Busck | 264/145 |
| 5510066 | April 1996 | Fink et al | 264/040.1 |
| 5521515 | May 1996 | Campbell | 324/674 |
| 5539292 | July 1996 | Vranish | 318/568.21 |
| 5726581 | March 1998 | Vranish | 324/688 |
| 6146567 | November 2000 | Sachs et al | 264/113 |
| 20020064745A1 | May 2002 | Schulman et al | 433/002 |
| 20040036200A1 | February 2004 | Patel et al | 264/401 |
| 20040145088A1 | July 2004 | Patel et al | 264/463 |
| 20050110177A1 | May 2005 | Schulman et al | 264/016 |

FOREIGN PATENT DOCUMENTS

| | | |
|---|---|---|
| EP0904158B1 | July 2002 | European Pat. Off. |
| EP1491516A2 | December 2004 | European Pat. Off. |
| GB8705408A | April 1987 | UK Pat. Off. |
| GB2277291A | October 1994 | UK Pat. Off. |
| WO9526871A1 | October 1995 | WIPO. |

### OTHER PUBLICATIONS

“Ferrocement: Applications in Developing Countries,” Ad Hoc Advisory Panel of the Board of Science and Technology for International Development, Office of the Foreign Secretary, National Academy of Sciences, February 1973.

Abercrombie, Stanley, Ferrocement: Building with Cement, Sand, and Wire Mesh, Schocken Books, 1973

Naaman, Antoine E., Ferrocement and Laminated Cementious Composites, University of Michigan, 2000.

“Contour Crafting,” retrieved Dec. 21, 2005 from http://www.contourcrafting.org.

“Ferrocement Educational Network,” retrieved Dec. 21, 2005 from http://ferrocement.net.

“Layered Material Technology for Rapid Prototyping, Modeling, Pattern Making, Production Tooling and Manufacturing,” retrieved Dec. 27, 2005 from http://www.cubictechnologies.com.

“Rapid Prototyping Primer,” retrieved Dec. 27, 2005 from http://www.mne.psu.edu/lamancusa/rapidpro/primer/chapter2.htm.

The invention is directed towards methods and systems for fabrication of three-dimensional objects. In the following description, numerous details are set forth for purpose of explanation. However, one of ordinary skill in the art will realize that the invention may be practiced without the use of these specific details. In this evolving area of technology, there has been a desire to provide new methods of manufacture that are relatively easy to employ, provide rigid structures, and are relatively quick in the formation of such three-dimensional objects. Thus, additional methods and systems that meet these criteria would be advancement in the art.

Three Dimensional Printing (MIT) and other laminar prototyping plotters form three-dimensional objects a layer at a time. These usually are on a desk scale and use gantry techniques to convey new materials to subsequent layers. The TDP from MIT is clearly inappropriate technology for full scale building construction since it lowers the work piece on a piston as each layer is added. For prototype scale items this technique is fine. On the residential home scale the piston is quite impractical.

Extrusion of wet materials to form complex concrete structures with voids left void, as is practiced by Contour Crafting, has its strengths and areas of application. It will remain limited by the requirement for high early strength of the extruded wet mixture. The present invention in contrast is vulnerable to high costs for very dry sand in great quantity but is insensitive to slow cure rate in terms of throughput per capital invested.

Classical manual ferrocement construction using cheap or free labor in great spikes of effort by a large available work force will remain popular in places where that cheap, large workforce is at hand and Computer Aided Manufacturing mobile roBOTs (cambots) are not. There is some prior art here visible. Archives of mailing lists discuss “dry placement” of simple, sometimes reinforced concrete structures (e.g. stepping stones, floors, etc.) with complete construction prior to infusion with water appears in the instructions. I recall an article in a Popular Mechanics or Popular Science magazine, dating back well over ten years, extolling the compressive strength virtues of dry, highly compacted, then flooded cement construction. Search as I might, I have not been able to find the article. None of these anecdotal references that I have found use the dry placement to make automation of ferrocement a practical pursuit. None of the rapid prototyping techniques I found support the means of conveyance on the laminar stack. Indeed, many RP models are fragile as initially produced. Of course, if the conveyance is externally supported it is not being used to provide compaction.

Many of the technologies used in embodiments of this patent to implement navigation, conveyance, robot motion control, and imaging are contained in prior art and licensing may well be needed for this IP as used for various implementations of the present invention. NASA's “capaciflector array” imaging technique appears to be very valuable since it “see”s permittivity of objects that may allow visibility into the matrix. Visibility of already placed reinforcement steel wire can facilitate custom strengthening with strategically placed reinforcement. PVC breadcrumbs and alignment marks could be cheap and effective imbedments visible at depth.

### BRIEF SUMMARY OF THE INVENTION

This invention relates generally to the production of architectural objects directly from a computer model by three-dimensional plotting performed by a crew of Computer Aided Manufacturing roBOTs, or cambots. This method allows automated construction of large-scale complex architectural shapes, such as residences with some of the characteristics of ships. Houses that do not lose their structural integrity if they start floating in a flood could have obvious advantages over submerged conventional housing.

### BRIEF DESCRIPTION OF THE SEVERAL VIEWS OF THE DRAWING

The invention can be described in more detail with the help of the accompanying drawings wherein

FIG. 1 shows site moisture control; and

FIG. 2 shows possible Computer Aided Manufacturing roBOTs' or cambots' resources.

### DETAILED DESCRIPTION OF THE INVENTION

The present patent provides means of constructing a three-dimensional matrix of geographically patterned construction materials. The “matrix” includes material that provides temporary support during placement of the various materials composing the entire matrix. This temporary material henceforth called “fill” is that material that at some later point in the construction process may be removed without practical impact to the structures produced by this means.

Construction Materials and Fill

There are many commercially available construction materials and fill that may be used in accordance with embodiments of the present invention. Construction materials and fill may include:

a) solid-phase granular materials of a full spectrum of uniform or non-uniform particle size and size distributions that require no individual particle orientations during placement making them compatible with mechanized aggregate placement by automatic equipment designed for conveyance and accurate placement of bulk granular materials on a surface such as the laminations of the present invention.

b) solid-phase fibers of a full spectrum of uniform and non-uniform fiber composition, a full spectrum of uniform and non-uniform fiber geometries that may or may not require specific orientation, may or may not in their placement span laminations from the current lamination in progress;

c) materials applied to a lamination in a non-solid phase or fluid form as gases, sprays, aerosols, strands, streams, or globs that may or may not contribute to local tensile strength within or across the current or multiple laminations but any tensile strength contribution so acquired is secondary to the tensile strength purposely achieved during bulk activation in the present invention; or

d) fixtures or subassemblies placed with or without specific orientations at the current lamination but that may or may not extend into previous laminations and that may protrude from the current laminations to become part of subsequent laminations.

Construction materials and fill may include a single item enumerated above or any combinations thereof.

Plotting of Dry Material

Plotting of dry material can be done in many ways including but not limited to:
Electrostatic plotting
Pneumatic Conveyance Plotting
Mechanical Screw Conveyors
Weighed Belt Conveyors
Rotating Bucket Belts
Other Means of Varying Precision (any which do not add water)

Various fixtures (e.g. bolts) can be applied as the construction proceeds by various means such as pick and place bots which may be ambulatory (or not). Materials and fixtures can be delivered to placement bots by freighter bots. Shim form bots can conveniently receive materials from above delivered by freighter bots. Ambulatory bots might travel to delivery sites to acquire materials or receive fixtures or materials from freighter bots.

Ferrocement Characteristics

Ferrocement is understood within the art as a reinforced cementitious material with a specific set of characteristics advantageous in various applications. Ferrocement formed as in claim 1 differs from traditional ferrocement with respect to the method of fabrication since traditional ferrocement fabrication does not follow this lamination process. In particular, ferrocement tensile strength in traditional processes usually must be provided by the reinforcement first, before the cementitious material is applied. The reinforcement must also provide adequate compressive strength during the application of the uncured cementitious material to support the mass of the unhardened structure. Traditional ferrocement construction also involves a period of great labor expenditure to gain good coverage of the reinforcement with cementitious material that has already been activated. Ferrocement produced with the claim 1 method does not require early strength, the activation can be deferred for extended periods of time, and it is quite amenable to total automation.

Site Preparation for the Dry Construction Processes

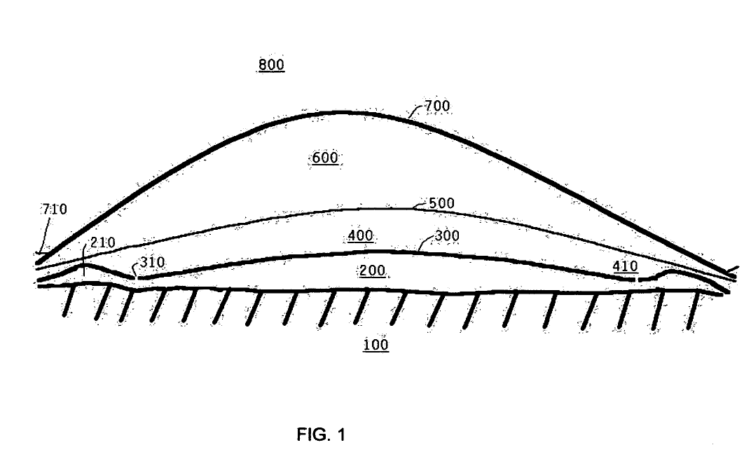

FIG. 1 facilitates an explanation of site moisture control. To prevent moisture from entering the construction material (400) during the dry construction process, some general site preparations should typically be provided. Moisture could enter the material from atmospheric precipitation (in 800) so a site cover (700) should normally direct all precipitation moisture towards the outer perimeter (710) of the site. Moisture present in the underlying soil (100) might also diffuse upward into the site or wick up through the material via capillary action. A lower moisture barrier (300) is generally appropriate to minimize this infusion of moisture. The lower moisture barrier (300) can also direct any leaks from the site cover (700) outward and away from the material of the site to minimize the impact from such a leak.

The site cover (700) and/or the lower moisture barrier (300) in one embodiment might be a continuous polyethylene film of perhaps 6mils thickness. The lower moisture (300) barrier might be supported by a gently domed layer of base fill material (200) starting with very coarse aggregate covered with progressively finer aggregate layers until a sand layer is completed at the top of the base fill material (200). This arrangement could provide both the desired shaping of the lower moisture barrier film (300) and protection for the film (300) from puncture which might result from direct contact with coarse aggregate immediately beneath the moisture barrier film (300). The base fill layer (200) could be all fine sand if layering is impractical or too costly. The tradeoff is the loss of some resistance to foundation material erosion and greater risk of additional settling with sand only.

The described mound of aggregate and sand (200) might have a perimeter mound (210) that forms a trough (410) between it and the overall mound. Perforations (310) in the film (300) near the bottom part of that trough might allow flowing water to pass out of the actual construction zone (400) and into the underlying base (200) to be carried away through the local water table in the earth (100). This water will therefore not accumulate in trough (410) and will by this means avoid damaging amounts wicking up into the dry construction material layer (400).

Any seams in the films should be glued with the upper film overlapping on top of the lower film of that same layer. This forms a “shingle layering” which will have less tendency to trap and eventually pass through any water in the seam into the dry construction material layer (400).

The site cover (700) can be inflated with blower(s). The blowers could blow air from the atmosphere if it is dry enough or could provide dried air if the atmospheric air is moist or if additional moisture needs to be removed from the air in the activity space (600). Temperature control of the air in the activity space (600) is possible with heaters or coolers connected to the blowers if temperature control is desired. Temperature control might be important if condensation on the underside of (700) is detected or anticipated. Some small residual moisture in the “dry” material (400) could be removed with climate control of the activity space (600) especially if no cementitious material has yet been placed. The blowers do not need to provide much flow since the site cover (700) should have insignificant leaks. The site cover also provides dust containment within the construction activity zone (600).

In one embodiment the moisture barriers might also have metallization which would allow them to form the plates of a capacitor. Charged construction particles could be electrostatically driven to the current layer of construction (500) to be deposited on areas that have been pre-patterned with the opposite charge to attract the aerosol charged particles. This mechanism requires careful control of moisture levels in the air (600), the matrix (400), and particularly on the matrix surface (500). The matrix surface would behave like the collector plate of an enormous electrostatic dust precipitator. The patterning of charge on the matrix surface would cause it to act like an electrostatic plotter where the materials being deposited would be analogous to the electrostatic inks. The potential resolutions of this application of electrostatics is way higher than the resolutions typically required for large structure construction but the variations in the materials being placed will need to be much lower than current construction quality control produces to make the process work reliably. Electrostatic pre-patterning is a delicate proposition that might easily send previously placed particles flying away in search of instant electrical neutrality instead of quietly resting until oppositely charged aerosols arrive.

The matrix lamination forming at (500) can also be constructed with pneumatic or mechanical dry material conveyances from mobile robots with more off-the-shelf implementations of precision dry material delivery. It is possible to use combinations of such delivery mechanisms appropriate to the resolution required at the particular x and y location receiving the new material from drug quantities to dump trucks and graders. The trick is to dynamically adjust the resolutions by measuring the placed material at speed while plotting the next layer and rapidly adapting to how the material of the previous delivery has distributed. Sometimes additional compaction passes and additional perception passes will be in order when moving to higher resolutions. Sometimes intermediate resolutions will be required to move from high resolution to very low resolution without disrupting the precision achieved with the high resolution on subsequent very low resolution passes. The command and control processor(s) must orchestrate the interfaces between high and low resolution in all dimensions to make the result seamless.

Upon completion of the placement of all material in the construction matrix (400) the same moisture barriers (300) and (500) may in some embodiments be used to establish and maintain the proper conditions to “set” the structures developed in matrix (400). In the case of water activation of portland cement for example, the matrix (400) will need protection from drying until the entire desired strength of cementitious material has been reached. Simple water misters immediately past the blowers and/or at the very top of the mound can provide the necessary activator (typically clean, potable water) to start and maintain the crystalization process of the active chemicals from the portland cement. The water applied must not be so much as to erode the matrix and once the matrix is saturated, little or no additional water need be added since the moisture barriers should severely limit evaporation.

In the embodiment using a flexible site cover (700), the activity zone (600) can be evacuated of cambots and deflated once the construction activity is done. Sand can be added on top of the site cover to reduce wind agitation of the site. Huge amounts of sand may be piled on the work site since any additional compaction results in a higher density and strength of the resulting structure. In one embodiment, activation fluid infusion is achieved via small-perforated pipes in the bottom of the matrix after piling several stories of sand on top of the site (800) to gain high compaction and thus very high strength. If high compaction is planned, hollow fixtures that might be crushed must be prepacked with sand and no compressibles (like styrene foam) should be used in the site without preplanning their compression implications from the point of their use upward.

Central Control Computer Complex (C4 or “The Farm”) and Cambot Crew Logistics

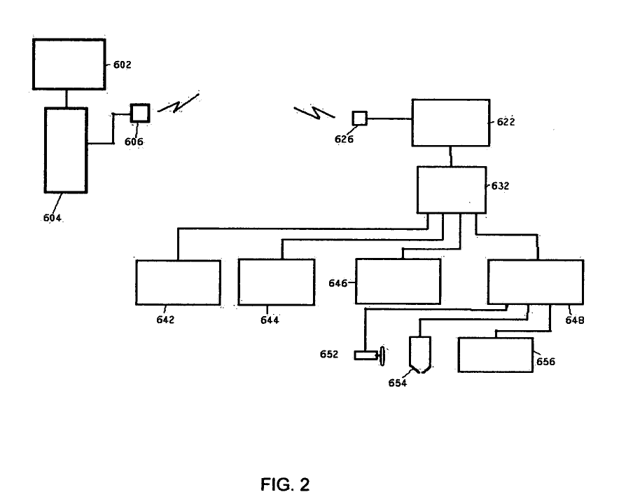

FIG. 2 facilitates the explanation of possible Computer Aided Manufacturing roBOTs' or cambots' resources present at the building site. One or more computers may direct the activities of cambots on the construction site.

In one embodiment, C4 consists of one fairly capable computer communicating via WiFi to a crew of 1 vision cambot and 4 low cost mechanical plotter cambots. The C4 constructs orders for each cambot using the set of all outstanding orders to insure that no collisions are being dispatched. The C4 directs cambots with specific skills to perform tasks within each cambot's skill set. A visual cambot is in the crew with a lidar, a capaciflector, four colored pozzolan(diatomaceous earth) low-flow bins, and a color video camera. The dye's are water-soluble and will dissipate once the activation water infuses into the matrix.

The crew also has four cambots each with a color video camera and a plotter bin. The plotter bins have a screw feed at the bottom and are open at the top for refilling. These low cost plotter cambots have no plotter articulation and no steering except that there is a simple hinge between the fuselage shell mounting the front wheels and the fuselage shell mounting the back wheels. The hinge has a protractor that appears at the edge of the video camera display and software downloaded at boot time in the cambot translates the video display into an angular value indicating the current angle of the hinge in a one byte integer from −120 to zero to +120 in quarter degrees. There is a physical rubber bumper in both directions at 30 degrees so the maximum turning angle is 30 degrees in either direction which is just a little before the large, treadless balloon tires of the front would scrub against similar tires on the back. In normal plotting operation the angle remains very close to 0. There is a long vertical pin forming the fuselage hinge so there is only one degree of freedom in the hinge and no up and down motion at the hinge pin. Each of the four wheels have a stepper motor with a worm gear held against a large disk gear that turns with the wheel. The disk gear has teeth with a semicircular groove for the worm gear and the worm gear has a spring tensioner holding it against the disk gear so there is no apparent backlash when the stepper motor reverses. The bins have a mechanical screw feed at the bottom of each hopper driven by similar stepper motors through a reduction gear train for each screw feed. There are large hoppers off the matrix to reload the cambot hoppers using similar but larger screw feeders. These refill hoppers are reloaded by a human attendant with a skid-steer loader. The platforms beneath the cambots sitting under the hopper reloaders are weighing scales readable by C4 to keep logs of material feeds and speeds.

A low cost plotter cambot transmits a color video image to the C4 each time it moves one half of a video frame. If the video frame shows any color assigned to the current cambot then C4 calculates the command sequence required to have that cambot eject material in a way calculated to cover that color strip with the correct construction material covering and thus obscure the color. Subsequent robots with that trail in their video are used by C4 to determine the degree of success of the previous low cost plotter cambot. The amount of material required to cover a color trail is about 10 times the amount of material in the trail itself. A color trail is wide and just thick enough to show the fully saturated color. The covering trail is about the same width as the color trail but about 10 times as thick as the color trail. The covering trail has the materials ratios pre-adjusted to compensate for the additional 10% dyed pozzolan contributed by the color trail.

The visual cambot has better movement motors and better control over its movement. The pozzolan bins can move somewhat left and right as the visual cambot travels and can plot under and beyond the wheels of the visual cambot as it moves along. Some bins on this cambot are left and right eject bins to allow the visual cambot to directly plot covering quantities of materials right up to the edge of vertical obstructions. That is, the visual cambot plots those areas, if any, beyond the reach of the low cost plotter cambots. Since the visual cambot knows with great accuracy where it is globally and with respect to earlier plot activity, it can make precise corrections of anomalies generated by the low cost plotter bots if necessary. The visual cambot moves much faster than the low cost plotter cambots and it must gain a bit of a lead before the low cost plotter cambots will have an opportunity to work at full speed since the C4 will hold them back until they can operate without danger of collision from the orders issued. C4 directs the visual cambot to map the current state of the construction site as a data baseline before any color trails or other plotting begins. Then C4 directs the visual cambot to begin plotting specific color trails to continue the design development while maintaining specifications for laminar design. C4 can dispatch low cost robots in either direction along their color trails and can dispatch them regardless of the age of the color trail. With traffic some color trails may become distorted or obliterated. Since C4 knows where they should be some noise in the actual line itself is irrelevant and the lines could actually be dashed or otherwise incomplete without significant ill effect. The color lines are more of a quality control measurement of the real-time performance of low cost plotter robots than absolute specifications for construction. Color trails do provide some degree of hidden line logic but that should be repeated in the C4 plotting logic and color lines covered at intersections should be used to check the logic.

This embodiment is a very practical example of Laminar Automated Construction crew logistics with a budget minded resource allocation. Most of the hardware assets can be assembled with off-the-shelf commodities. The C4 and resident cambot software probably needs a project development effort and a period of testing and debugging. Object oriented programming methods for cambot behaviors might take some design work but then could be reused on a very large number of widely varied projects. Some laminar CAD software probably already exists and could be leveraged to produce optimized order stream generation for cambots.

CamBot Information Technology for Laminar Automated Construction

In one embodiment, Cambots (Computer Aided Manufacturing mobile roBOTs) for dry laminar automated construction will use:

WiFi, e.g. 802.11g

(access point or router for communication to and from the site Central Control Computer Complex (C4 or “the farm”))

Thin Client Computers

(boot via the wan(wifi) and support USB and Ethernet)

USB Hub

USB interface Lidar

(detects retroreflective beacons to calculate cambot position relative to site benchmarks)

A Cambot High Resolution gps

(provides global coordinates at the construction site)

USB Capaciflector Imager

(NASA developed technology to image permittivity at a distance)

(images embedded material permittivity for -z perception of matrix)

(looks down through matrix structure below this x1,y1 x2,y2)

(useful to adjust for interlaminar distortions of matrix)

USB Interface Optical Camera

(detects alignment marks in immediately previous lamination)

(most cambots only need this because high visibility cambots with Lidar and or Capaciflectors provide paint-by-numbers style top lamination markings in Water-soluble dye powder laced plotted material visible to optical cameras)

USB to Parallel Ports for Digital Input and Output or Other Interfaces to:

Control Mobility Motors (open or closed loop control, smoothed starts and stops)

Convey Material Using
Pick & Place
OTS Mechanical Conveyance and precision placement of Dry Granular Material
OTS Pneumatic Conveyance and precision placement of Dry Granular Material
Electrostatic Conveyance and high precision placement of Dry Powdered Material
   Software Resident in Robot's Thin Client Computer:

Analyzes and compares images to achieve registration of plotter mechanism

Analyzes and compares images to achieve coarse cambot positioning

Transfers selected images to C4

Implements command sequences from C4

Provides smooth starts and stops

Provides off-matrix cambot positioning fixed action patterns

(reload material 1, get turned around, recharge, retire . . . )

Provides matrix edge cambot alignment fixed action pattern

Panic emergency kill (I am lost, collision detection . . . )

Bots Categorized by Laminar Areas Covered

Coverage means the bot can apply desired materials to the current lamination.
1. Internal Pier
2. Extra Pier Clear Path
3. Extra Pier Obstructed Path Plotters
   1. Internal Pier:

Operate inside the walls of a pier. Preferably works up to the inner surface of the pier wall. Shimform bots can work very well here. Current lamination inside a pier can be somewhat different than the current lamination outside the pier.

2. Extra-Pier Clear Path:

Operate in the quickly navigable clear paths between piers. To allow higher speed operation without bumping piers, these may not be able to plot with zero margins from pier walls. Shimform bots may have a performance disadvantage when used in this area due to being localized to a specific pier.

3. Extra-Pier Obstructed Path:

Operate in the external near field of a pier covering areas not easily covered by Inter Clear Path Pier plotters preferably including all area right up to the outside wall of the piers.

Disaster Toughened Construction using Architectural Ferrocement Laminar Automated Construction Techniques

This discussion refers to Hurricane Toughening but such toughening might be somewhat effective against many other disasters including tsunamis, tornadoes, floods, earthquakes, missiles, hail, avalanche, mudslides, lightning, fires, stray vehicle collision, etc. Some embodiments of Architectural Ferrocement Laminar Automated Construction provide a means to construct Hurricane Toughened Residential and/or Commercial neighborhoods. Constructing buildings with chambers sealed from flooding so that buildings float for long enough to outlast storm surge and other short term flood events provides one hurricane toughened characteristic. Another is that ferrocement in curved (perhaps in more than one direction) surfaces is very resistant to impact damage from debris. If a developer connects (perhaps beneath the surface of the ground) a number of structures with a net of ropes/cables/beams/pipes, then those structures might be restrained from colliding with each other and might form a debris line mat which reduces damage from surf and wind for those structures embedded in the mat. Reduced damage might result from surf energy being dissipated as it encounters the mat due to chaotic reflections and friction with the debris. Structures forming the mat may also protect other structures whether hurricane toughened or not beyond the leading edge debris line. Hurricane toughened structures might incorporate rigging points for relocation after a disaster event using large cranes brought in for that purpose.

Ferrocement itself provides a great deal of toughening over other construction. Ferrocement is very robust building material with very high strength per material costs. Ferrocement has historically been ignored in developed countries because traditional ferrocement construction techniques have prohibitive labor costs. Automating ferrocement construction can provide all of the materials cost advantages, strength advantages, weight per total volume advantages, fire resistance advantages, low maintenance advantages, inherent water resistance advantages, and add to that great custom design flexibility and the great strength provided by nearly total control of complex shapes. Ferrocement has a long history of use as a boat building material where the builder was willing to expend the required labor. Appropriately formulated ferrocement is waterproof and resistant to the corrosive effect of seawater.

Extra toughening for coastal homes, homes in tornado alley with inner hardened safe rooms, hidden rooms for home invasion protection, built-in safe deposit boxes, loading docks, custom garages, fountains, gargoyles, unique statues, structural provision for building extensions, structures shaped like complex curved natural objects such as spiral shells, benches, pools, railings, integrated features with surface texturing and embedments, multilayer super insulation, integrated permanent guftering, etc. are all amenable to rapid prototyping implementations that vastly increase integration and reduce costs. The lower surface of the structure can be without (the usual) seams to limit insect access. There can be no termite structural damage to ferrocement. Storm covers for large openings can be built-in and super strong.

### Particular Embodiments of Present Invention

In many embodiments the outstanding feature of using Ferrocement Laminar Construction is the great flexibility of the construction with great labor reductions over other construction alternatives. With this construction process, a huge richness of design flexibility can be applied with off-the-shelf CAD/CAM software. Architects can exercise their creativity and home buyers can get their exact wishes granted.

Laminar construction with plotting resolution and embedded pick and place fixtures means that standard redecorating aftermarkets will spring up for homeowners to inexpensively make-over their dwelling. Internal walls can be hung on standard interface bolts and homeowners can therefore make sweeping changes to their decor with no special skills. Suspended ceilings, raised floors, built-in wiring and plumbing everywhere, structural storage on any/all walls without cabinetmakers, and the ability to build-in everything desired all mean greater control by the homeowner.

Graceful curves in the architecture are not a huge cost adder. Spiral stairways, long smooth access ramps, roof drainage through embedded atria for impervious cover penalty avoidance, huge overhangs, other green, stylish and unique features, central courtyards, secret oriental gardens, water features, saunas, open sky showers, etc. can all be integrated into a home design with huge cost savings over traditional methods.

Some embodiments of the invention provide a method for organizing an assembly line redevelopment of a disaster-ravaged region to gain efficiencies in economies of scale for the construction and coherence of planning for toughening against disaster recurrence.

Some embodiments of the invention provide a method for organizing a strong collective defense against specific local dangers, such as interconnected tornado escape routes for an entire neighborhood to a central subterranean shelter.

In some embodiments of the invention, each cambot can have special features permitting specialized behaviors.

Some embodiments of the invention create raceways for infrastructure such as pipes and wires, rigging points for relocation, foam floatation chambers for an unsinkable structure. p Some embodiments of the invention create the matrix in a rotating cylinder such that centripetal accelerations of the material away from the cylinder's axis of rotation determine the direction of laminar progression instead of gravity.

Other embodiments contemplated include but are not limited to

1. A method for laminar fabrication of a three-dimensional object or a multiplicity of three-dimensional objects comprising:
a) depositing construction materials and fill in defined regions in laminations;
b) repeating step a) such that multiple layers of materials purposefully align to achieved regions of previous laminations to form a matrix;
c) developing tensile strength where required in the matrix; and
d) removing the fill to reveal the three-dimensional object or the multiplicity of three-dimensional objects formed.

2. A method as in claim 1, wherein the construction materials and fill are selected from the group consisting of:
a) solid-phase granular materials of a full spectrum of uniform or non-uniform particle sizes and size distributions that require no individual particle orientations during placement making them compatible with mechanized aggregate placement by automatic equipment designed for conveyance and accurate placement of bulk granular materials on a surface such as the laminations in claim 1;
b) solid-phase fibers of a full spectrum of uniform and non-uniform fiber composition, of a full spectrum of uniform and non-uniform fiber geometries that may or may not require specific orientation and may or may not in their placement span laminations from the current lamination in progress;
c) materials applied to a lamination in a non-solid phase or fluid form as gases, sprays, aerosols, strands, streams, or globs that may or may not contribute to local tensile strength within or across the current or multiple laminations but those are secondary in their tensile strength contribution to the three-dimensional or the multiplicity of three-dimensional objects in claim 1 relative to the tensile strengths step c contributed to the three-dimensional or multiplicity of three-dimensional objects in claim 1;
d) fixtures or subassemblies placed with or without specific orientations at the current lamination but that may or may not extend into previous laminations and that may protrude from the current lamination to become part of subsequent laminations; or
e) combinations thereof.

3. A method as in claim 1, wherein the three-dimensional object or the multiplicity of three-dimensional objects formed use materials and geometries consistent with considering all or part of the three-dimensional objects or the multiplicity of three-dimensional objects to be ferrocement.

4. A system for fabrication of a three-dimensional object or a multiplicity of three-dimensional objects comprising:
a patterned aggregation of construction materials and fill arranged in a laminar matrix allowing deferred development of tensile strength of constructed objects; and
an activator or a multiplicity of activators to produce the tensile strength in the constructed objects.

5. A system as in claim 4, further comprising a conveyance of one or a multiplicity of fluid tensile strength activators infused into defined volumes of the matrix through the spaces between the solid-phase materials of the matrix via any means which minimally disrupts the achieved placement of materials in the matrix including but not limited to sprays from the active zone (600), flooding of the matrix, channels, pipes, tubes or defined areas of enhanced fluid flow within the matrix, capillary action of materials within the matrix, diffusion of fluids into the fluids currently present in the matrix, and modifications of fill areas of the matrix to channel the activator fluid.

6. A system as in claim 4, further comprising an introduction of a tensile strength activating energy or a multiplicity of activating energies alone or in combination with fluid activation as in claim 5 into defined volumes of the matrix including but not limited to acoustical, thermal, electrical, mechanical, or electromagnetic energy.

7. A system as in claim 4, further comprising a crew of one or more Computer Aided Manufacturing roBOTs, or cambots, collectively capable of constructing the laminations of the construction materials and fill with the materials appropriately placed in the laminar matrix so that with compression the materials come to rest in the appropriate locations to form the three-dimensional objects once their tensile strength is developed.

8. A cambot as in claim 7, comprising a mobile entity capable of traversing the laminar matrix without disruption of placed materials by any means including but not limited to Low-pressure tires, restricted steering movements, minimal tread tires, tires designed to pack the matrix without disruption, non-disruptive walkers, pier walkers, and mobile gantries.

9. A cambot as in claim 4, comprising a site position locator capable of sensing with adequate accuracy and precision the cambot's own locations relative to construction site benchmarks via any means or combination of means of location including but not limited to lidar, laser rangefinder imaging, dead reckoning, radar, machine vision, open loop calculation, skyline imaging, beacon detectors, mechanical limits, high precision global positioning systems (gps), encoded tape measures, radio direction finding, ultrasound ranging, and site imaging interpretation.

10. A cambot as in claim 8, comprising a matrix penetrating imager capable of imaging features within the matrix under the cambot via any means or combination of means including but not limited to the NASA imaging capaciflector array, metal detectors, x-ray imagers, radar, sonar, and probes.

11. A cambot as in claim 8, comprising a surface pattern imager for acquiring images formed by material appearing in the surface of the matrix via any means or combination of means of acquiring such an image including but not limited to black and white and color video cameras, bar code readers, chemical sensors, photosensors, electrostatic sensors, magnetic sensors, permittivity sensors, permeability sensors, proximity sensors, displacement sensors, acoustic imagers, and probes.

12. A cambot as in claim 8, comprising a surface pattern maker capability intended apply surface patterns to be read by claim 11 capable cambots and used to determine the claim 11 cambot's position and orientation either by interpretation directly in the claim 11 cambot or elsewhere.

13. A cambot as in claim 7, comprising a command and control capability or a multiplicity of command and control capabilities using any means including but not limited to cambot communications, cambot command sequence generation and tracking, cambot collision avoidance, cambot policing, cambot imaging analysis, lamination distortion analysis, human interfaces, project coordination, movement logistics, work progress optmization, thin client boot image loader, cambot specialization modeling, construction materials inventory control, maintenance scheduling, malfunction detection, damage control and recovery, fuel and energy management, atmospheric and matrix parameter monitoring, fill material reuse and reconditioning planning, records logging, cost control, and schedule tracking and analysis.

14. A cambot as in claim 8 comprising a material placement capability providing for accurate deposition of appropriate solid-phase materials at the current lamination via any means or combination of means of material conveyance, metering, placement and oriented placement including but not limited to pick and place, dry granular belt feed, dry granular screw feed, extrusion feeds of granular particles, extrusion feeds of molten material that becomes solid shortly after exiting the extrusion orifice, fiber feeds, mechanical wire feed and cut, pneumatic dry particle stream feeds, pneumatic molten material sprays, pneumatic solvent sprays that dry to a solid aerosol before the solvent can reach significant quantities of activatable material, pneumatic fiber feed, and electrically charged particle feed.

15. A cambot as in claim 8 comprising a material placement capability providing for accurate deposition of appropriate fluid materials at the current lamination via any means or combination of means of material conveyance, metering, placement and oriented placement including but not limited to activator sprays, ribbons, and streams Those activate some of the matrix to produce some localized tensile strength from that activation but that do not activate the entire claim 1 object materials but do cause sufficient activation to produce enough tensile strength to stabilize the current lamination, activator or other fluid sprays, ribbons, and streams that carry suspended solids or dissolved solutes to place these carried materials into the matrix without activation of the entire claim 1 object materials, activator or other fluid sprays, ribbons, or streams applied to establish surface or other defined area characteristics of ultimate objects such as paints, colorants, and texturizers, electrically charged droplet feed that does not activate all the claim 1 object materials.

16. A cambot as in claim 8, comprising an electrostatic patterning device which applies an electrostatic charge pattern on the current surface of the matrix to prepare for electrostatic deposition of materials.

17. A mutiplicity of objects as in claim 1 and preferentially as in claim 3 possibly including structures not formed as in claim 1 comprising a “hurricane toughened” development or neighborhood of structures with interfaces collectively designed and multiply interconnected with somewhat compliant tensile and compressive elements and positive and negative buoyancy elements connected via embedded rigging points for individual structure attachment to the aggregate that double in the aftermath of a disaster as a means of reliable, high strength rigging attachment for individual structure relocation with large cranes or by dragging with bulldozers or towing with boats and that assemblies in aggregate form an “engineered debris line” to resist and dissipate the energy of a violent phenomenon and to minimize damage to embedded structures and even to shield structures beyond the engineered debris line from the full force of violent phenomena including but not limited to hurricanes, tsunamis, tornadoes, floods, earthquakes, missiles, hail, avalanche, mudslides, lightning, fires, stray vehicle collision, explosions, and asteroid impacts.

While certain preferred embodiments of the present invention have been disclosed in detail, it is to be understood that various modifications may be adopted without departing from the spirit of the invention or scope of the following claims.

I claim:

1. A method for laminar fabrication of a three-dimensional object or a multiplicity of three-dimensional objects comprising:
a) depositing construction materials and fill in defined regions in laminations;
b) repeating step a) such that multiple layers of materials purposefully align to achieved regions of previous laminations to form a matrix;
c) developing tensile strength where required in the matrix; and
d) removing the fill to reveal the three-dimensional object or the multiplicity of three-dimensional objects formed.

2. A method as in claim 1, wherein the construction materials and fill are selected from the group consisting of:
a) solid-phase granular materials of a full spectrum of uniform or non-uniform particle sizes and size distributions that require no individual particle orientations during placement making them compatible with mechanized aggregate placement by automatic equipment designed for conveyance and accurate placement of bulk granular materials on a surface such as the laminations in claim 1;
b) solid-phase fibers of a full spectrum of uniform and non-uniform fiber composition, of a full spectrum of uniform and non-uniform fiber geometries that may or may not require specific orientation and may or may not in their placement span laminations from the current lamination in progress;
c) materials applied to a lamination in a non-solid phase or fluid form as gases, sprays, aerosols, strands, streams, or globs that may or may not contribute to local tensile strength within or across the current or multiple laminations but those are secondary in their tensile strength contribution to the three-dimensional or the multiplicity of three-dimensional objects in claim 1 relative to the tensile strengths step c contributed to the three-dimensional or multiplicity of three-dimensional objects in claim 1;
d) fixtures or subassemblies placed with or without specific orientations at the current lamination but that may or may not extend into previous laminations and that may protrude from the current lamination to become part of subsequent laminations; or
e) combinations thereof.

3. A method as in claim 1, wherein the three-dimensional object or the multiplicity of three-dimensional objects formed use materials and geometries consistent with considering all or part of the three-dimensional objects or the multiplicity of three-dimensional objects to be ferrocement.

4. A system for fabrication of a three-dimensional object or a multiplicity of three-dimensional objects comprising:
a patterned aggregation of construction materials and fill arranged in a laminar matrix allowing deferred development of tensile strength of constructed objects; and
an activator or a multiplicity of activators to produce the tensile strength in the constructed objects.

5. A system as in claim 4, further comprising a conveyance of one or a multiplicity of fluid tensile strength activators infused into defined volumes of the matrix through the spaces between the solid-phase materials of the matrix via any means which minimally disrupts the achieved placement of materials in the matrix including but not limited to sprays from the active zone (600), flooding of the matrix, channels, pipes, tubes or defined areas of enhanced fluid flow within the matrix, capillary action of materials within the matrix, diffusion of fluids into the fluids currently present in the matrix, and modifications of fill areas of the matrix to channel the activator fluid.

6. A system as in claim 4, further comprising an introduction of a tensile strength activating energy or a multiplicity of activating energies alone or in combination with fluid activation as in claim 5 into defined volumes of the matrix including but not limited to acoustical, thermal, electrical, mechanical, or electromagnetic energy.

7. A system as in claim 4, further comprising a crew of one or more Computer Aided Manufacturing roBOTs, or cambots, collectively capable of constructing the laminations of the construction materials and fill with the materials appropriately placed in the laminar matrix so that with compression the materials come to rest in the appropriate locations to form the three-dimensional objects once their tensile strength is developed.

8. A cambot as in claim 7, comprising a mobile entity capable of traversing the laminar matrix without disruption of placed materials by any means including but not limited to Low-pressure tires, restricted steering movements, minimal tread tires, tires designed to pack the matrix without disruption, non-disruptive walkers, pier walkers, and mobile gantries.

9. A cambot as in claim 4, comprising a site position locator capable of sensing with adequate accuracy and precision the cambot's own locations relative to construction site benchmarks via any means or combination of means of location including but not limited to lidar, laser rangefinder imaging, dead reckoning, radar, machine vision, open loop calculation, skyline imaging, beacon detectors, mechanical limits, high precision global positioning systems (gps), encoded tape measures, radio direction finding, ultrasound ranging, and site imaging interpretation.

10. A cambot as in claim 8, comprising a matrix penetrating imager capable of imaging features within the matrix under the cambot via any means or combination of means including but not limited to the NASA imaging capaciflector array, metal detectors, x-ray imagers, radar, sonar, and probes.

11. A cambot as in claim 8, comprising a surface pattern imager for acquiring images formed by material appearing in the surface of the matrix via any means or combination of means of acquiring such an image including but not limited to black and white and color video cameras, bar code readers, chemical sensors, photosensors, electrostatic sensors, magnetic sensors, permittivity sensors, permeability sensors, proximity sensors, displacement sensors, acoustic imagers, and probes.

12. A cambot as in claim 8, comprising a surface pattern maker capability intended apply surface patterns to be read by claim 11 capable cambots and used to determine the claim 11 cambot's position and orientation either by interpretation directly in the claim 11 cambot or elsewhere.

13. A cambot as in claim 7, comprising a command and control capability or a multiplicity of command and control capabilities using any means including but not limited to cambot communications, cambot command sequence generation and tracking, cambot collision avoidance, cambot policing, cambot imaging analysis, lamination distortion analysis, human interfaces, project coordination, movement logistics, work progress optmization, thin client boot image loader, cambot specialization modeling, construction materials inventory control, maintenance scheduling, malfunction detection, damage control and recovery, fuel and energy management, atmospheric and matrix parameter monitoring, fill material reuse and reconditioning planning, records logging, cost control, and schedule tracking and analysis.

14. A cambot as in claim 8 comprising a material placement capability providing for accurate deposition of appropriate solid-phase materials at the current lamination via any means or combination of means of material conveyance, metering, placement and oriented placement including but not limited to pick and place, dry granular belt feed, dry granular screw feed, extrusion feeds of granular particles, extrusion feeds of molten material that becomes solid shortly after exiting the extrusion orifice, fiber feeds, mechanical wire feed and cut, pneumatic dry particle stream feeds, pneumatic molten material sprays, pneumatic solvent sprays that dry to a solid aerosol before the solvent can reach significant quantities of activatable material, pneumatic fiber feed, and electrically charged particle feed.

15. A cambot as in claim 8 comprising a material placement capability providing for accurate deposition of appropriate fluid materials at the current lamination via any means or combination of means of material conveyance, metering, placement and oriented placement including but not limited to activator sprays, ribbons, and streams Those activate some of the matrix to produce some localized tensile strength from that activation but that do not activate the entire claim 1 object materials but do cause sufficient activation to produce enough tensile strength to stabilize the current lamination, activator or other fluid sprays, ribbons, and streams that carry suspended solids or dissolved solutes to place these carried materials into the matrix without activation of the entire claim 1 object materials, activator or other fluid sprays, ribbons, or streams applied to establish surface or other defined area characteristics of ultimate objects such as paints, colorants, and texturizers, electrically charged droplet feed that does not activate all the claim 1 object materials.

16. A cambot as in claim 8, comprising an electrostatic patterning device which applies an electrostatic charge pattern on the current surface of the matrix to prepare for electrostatic deposition of materials.

17. A mutiplicity of objects as in claim 1 and preferentially as in claim 3 possibly including structures not formed as in claim 1 comprising a “hurricane toughened” development or neighborhood of structures with interfaces collectively designed and multiply interconnected with somewhat compliant tensile and compressive elements and positive and negative buoyancy elements connected via embedded rigging points for individual structure attachment to the aggregate that double in the aftermath of a disaster as a means of reliable, high strength rigging attachment for individual structure relocation with large cranes or by dragging with bulldozers or towing with boats and that assemblies in aggregate form an “engineered debris line” to resist and dissipate the energy of a violent phenomenon and to minimize damage to embedded structures and even to shield structures beyond the engineered debris line from the full force of violent phenomena including but not limited to hurricanes, tsunamis, tornadoes, floods, earthquakes, missiles, hail, avalanche, mudslides, lightning, fires, stray vehicle collision, explosions, and asteroid impacts.
